(19) United States
(12) Patent Application Publication
(10) Pub. No.: US 2024/0380285 A1
(43) Pub. Date: Nov. 14, 2024

(54) MOTOR, FLUID SUCTION DEVICE, AND CLEANER

(71) Applicant: Nidec Corporation, Kyoto (JP)

(72) Inventor: Ryoji YAMAUCHI, Kyoto (JP)

(21) Appl. No.: 18/659,494

(22) Filed: May 9, 2024

(30) Foreign Application Priority Data
May 12, 2023 (JP) 2023-079133

(51) Int. Cl. H02K 9/22; A47L 5/28; A47L 9/28; F04D 1/00; F04D 13/06; F04D 29/58; H02K 1/14; H02K 5/20; H02K 9/06

(52) U.S. Cl. CPC H02K 9/223; A47L 5/28; A47L 9/2889; F04D 1/00; F04D 13/0606; F04D 29/5806; H02K 1/146; H02K 5/207; H02K 9/06

(57) ABSTRACT

A motor includes a rotor and a stator. The rotor can rotate around a central axis extending in an axial direction. The stator rotationally drives the rotor. The stator includes a stator core, a coil portion, an inner casing, and a heat conductor. The stator core has an annular shape surrounding the central axis. The coil portion is located in the stator core. The inner casing surrounds and accommodates the stator core and the coil portion in the inside and holds the stator core. The heat conductor is in contact with an axial end portion of the coil portion and the inner casing.

### CROSS-REFERENCE TO RELATED APPLICATIONS

The present application claims priority under 35 U.S.C. § 119 to Japanese Patent Application No. 2023-079133, filed on May 12, 2023, the entire contents of which are hereby incorporated herein by reference.

### 1. FIELD OF THE INVENTION

The present disclosure relates to motors, fluid suction devices, and cleaners.

### 2. BACKGROUND

Conventionally, a device that sucks fluid such as an air flow containing liquid such as water by rotation of an impeller is known. In this device, a motor portion is surrounded by a housing and is separated from a flow passage of fluid.

However, in the conventional configuration of the motor portion, since the motor portion is surrounded by the housing, heat generated inside the housing (particularly, a coil portion) is hardly dissipated to the outside. Therefore, it is difficult to improve heat dissipation of the motor portion.

### SUMMARY

An example embodiment of a: motor of the present disclosure includes a rotor and a stator. The rotor is rotatable about a central axis extending in an axial direction. The stator rotationally drives the rotor. The stator includes a stator core, a coil portion, an inner casing, and a heat conductor. The stator core has an annular shape surrounding the central axis. The coil portion is located in the stator core. The inner casing surrounds and accommodates the stator core and the coil portion in the inside and holds the stator core. The heat conductor is in contact with an axial end portion of the coil portion and the inner casing.

An example embodiment of a fluid suction device of the present disclosure is capable of suctioning fluid. The fluid suction device includes the motor, an impeller, and an outer casing. The impeller is rotatable around the central axis together with the rotor of the motor. The outer casing surrounds a portion on another axial direction side of the motor and the impeller. A flow passage of the fluid is located between the outer casing and the portion on another axial direction side of the motor.

An example embodiment of a cleaner according to the present disclosure includes the fluid suction device described above.

The above and elements, other features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view illustrating a configuration example of a fluid suction device on which a motor is mounted according to an example embodiment of the present disclosure.

FIG. 2 is a perspective view illustrating an appearance of the fluid suction device.

FIG. 3 is an example embodiment of a schematic diagram of a cleaner on which the fluid suction device is mounted.

FIG. 4 is a perspective view illustrating a configuration example of a stator according to an example embodiment of the present disclosure.

FIG. 5 is a cross-sectional view illustrating an arrangement example of a second heat conductor according to an example embodiment of the present disclosure.

### DETAILED DESCRIPTION

Example embodiments will be described with reference to the drawings hereinafter.

Note that, in the present description, in a motor 100 and a fluid suction device 500, a direction parallel to a central axis CA is referred to as an “axial direction”. Of the axial directions, a direction from a circuit board 5 to a stator core 21 is referred to as “one axial direction Da”, and a direction from the stator core 21 to the circuit board 5 is referred to as “another axial direction Db”. Further, a direction orthogonal to the central axis CA is referred to as a “radial direction”, and a rotational direction around the central axis CA is referred to as a “circumferential direction”. Of the radial directions, a direction approaching the central axis CA is referred to as “radially inward”, and a direction away from the central axis CA is referred to as “radially outward”.

Further, in the present description, an “annular shape” includes not only a shape continuously connected without any cut along the entire circumference in the circumferential direction around the central axis CA but also a shape having one or more cuts in a part of the entire circumference around the central axis CA. Further, an “annular shape” also includes a shape having a closed curve around the central axis CA on a curved surface that intersects the central axis CA.

Further, in a positional relationship between any of an azimuth, a line, and a plane and another one of them, the term “parallel” includes not only a state in which they do not intersect even if they extend endlessly but also a state in which they are substantially parallel. Further, the terms “perpendicular” and “orthogonal” include not only a state in which both of them intersect at 90 degrees, but also a state in which they are substantially perpendicular and a state in which they are substantially orthogonal. That is, each of the terms “parallel”, “perpendicular”, and “orthogonal” includes a state in which a positional relationship between them has an angular deviation that does not depart from the gist of the present disclosure.

Note these terms are names merely for description, and are not intended to limit actual positional relationships, directions, names, and the like.

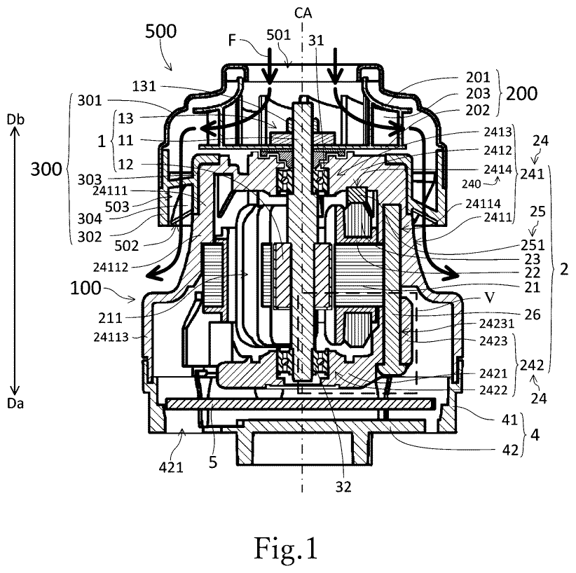

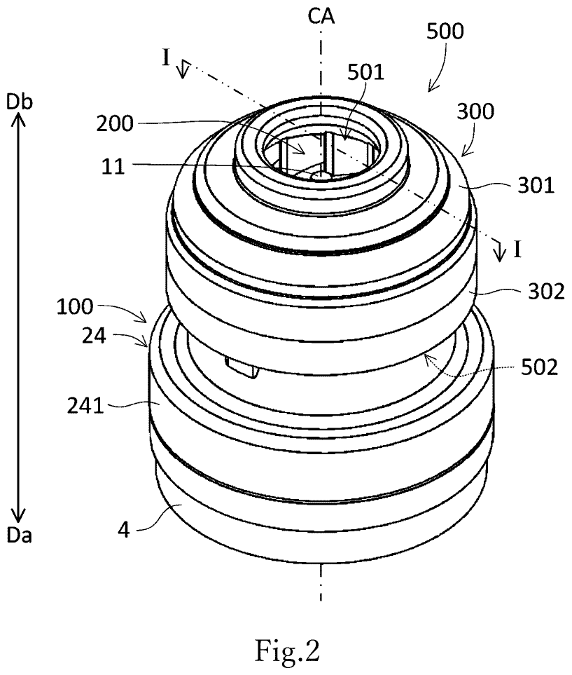

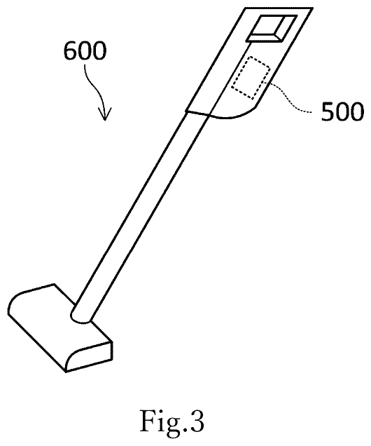

FIG. 1 is a cross-sectional view illustrating a configuration example of the fluid suction device 500 on which the motor 100 is mounted. FIG. 2 is a perspective view illustrating an appearance of the fluid suction device 500. FIG. 3 is an exemplary schematic diagram of a cleaner 600 on which the fluid suction device 500 is mounted. Note that FIG. 1 illustrates a sectional structure of the fluid suction device 500 taken along a virtual plane including two-dot chain line I-I and the central axis CA in FIG. 2. Further, in FIG. 1, a flow of fluid F is indicated by a thick arrow.

The fluid suction device 500 on which the motor 100 is mounted is capable of sucking the fluid F, and delivers the fluid F sucked from a suction port 501 to the outside from a delivery port 502. In the present example embodiment, the fluid F is mainly gas such as air, but may contain dust and liquid such as water. Alternatively, the fluid F may be liquid.

For example, as illustrated in FIG. 3, the fluid suction device 500 is mounted on the cleaner 600 capable of sucking dust and liquid such as water together with an air flow. That is, the cleaner 600 includes the fluid suction device 500. Note that, although the cleaner 600 is a stick type in FIG. 3, the present disclosure is not limited to this example, and the cleaner 600 may be a handy type or a canister type. In this manner, in the cleaner 600, heat dissipation of a motor portion can be improved as described later. However, application of the fluid suction device 500 is not limited to this example. For example, the fluid suction device 500 may be mounted on a device other than the cleaner 600 and used as, for example, a blowing device.

As illustrated in FIG. 1, the fluid suction device 500 includes the motor 100, an impeller 200, and an outer casing 300.

The motor 100 is arranged on the one axial direction Da side of the impeller 200, and rotationally drives the impeller 200.

The impeller 200 is rotatable around the central axis CA together with a rotor 1 of the motor 100. As described above, the fluid suction device 500 includes the impeller 200. The impeller 200 includes a bottom plate 201, an upper plate 202, and a plurality of rotor blades 203. The bottom plate 201 has a plate shape extending in the radial direction and surrounds a shaft 11 of the motor 100. An radially inner end portion of the bottom plate 201 is fixed to another axial end portion of the shaft 11 by a fixing member 13. The upper plate 202 has an annular shape surrounding the central axis CA and is arranged further in the another axial direction Db than the bottom plate 201. The rotor blade 203 is arranged radially outward between the bottom plate 201 and the upper plate 202, and a plurality of the rotor blades 203 are arranged in the circumferential direction. As each of the rotor blades 203 rotates in the circumferential direction around the central axis CA in accordance with rotation of the impeller 200, the fluid F is sucked from the suction port 501 and delivered radially outward from the impeller 200 through between the rotor blades 203 adjacent in the circumferential direction.

The outer casing 300 has a covered tubular shape extending in the axial direction, and accommodates a portion on the another axial direction Db side of the motor 100 and the impeller 200. As described above, the fluid suction device 500 includes the outer casing 300. The outer casing 300 surrounds a portion on the another axial direction Db side of the motor 100 and the impeller 200. A flow passage 503 of fluid is arranged between the outer casing 300 and a portion on the another axial direction Db side of the motor 100. The flow passage 503 is a wind tunnel in which the fluid F sucked from the suction port 501 and delivered from the impeller 200 flows toward the delivery port 502. The delivery port 502 is arranged in one axial end portion of the flow passage 503. A portion on the another axial direction Db side of the motor 100 (for example, a first tubular portion 24111 of a first inner casing 241 to be described later) faces the flow passage 503. Therefore, the motor 100 can efficiently dissipate heat to the fluid F flowing through the flow passage 503. Thus, heat dissipation of the motor 100 can be improved.

The outer casing 300 includes a first outer casing 301, a second outer casing 302, an attachment portion 303, and a stationary blade 304.

The first outer casing 301 has a covered tubular shape that opens toward the one axial direction Da and surrounds the central axis CA, and accommodates at least the impeller 200. The suction port 501 is arranged in a central portion of a lid portion of the first outer casing 301. A tubular portion of the first outer casing 301 extends in the one axial direction Da from a radially outer end portion of the lid portion.

The second outer casing 302 has a tubular shape surrounding the central axis CA, and extends in the one axial direction Da from one axial end portion of the tubular portion of the first outer casing 301. The second outer casing 302 surrounds a portion on the another axial direction Db side of the motor 100, and forms the flow passage 503 extending in the axial direction with a portion on the another axial direction Db side of the motor 100 (the first tubular portion 24111 of the first inner casing 241).

The attachment portion 303 is fitted and fixed to another axial end portion of the motor 100. By the above, the outer casing 300 is attached to the motor 100. Note that a fixing means is not limited to this example, and may be other than fitting, and may be, for example, bonding using an adhesive, brazing using silver wax or the like, welding, screwing, or the like.

The stationary blade 304 is arranged in the flow passage 503, extends at least in the axial direction, and straightens the fluid F flowing through the flow passage 503. A plurality of the stationary blades 304 are arranged in the circumferential direction. A radially outer end portion of each of the stationary blades 304 is connected to a radially inner surface of the second outer casing 302. A radially inner end portion of each of the stationary blades 304 is connected to the attachment portion 303. In the present example embodiment, the stationary blade 304 is integrated with the second outer casing 302 and the attachment portion 303.

Next, a configuration example of the motor 100 will be described with reference to FIGS. 1 and 2. The motor 100 includes the rotor 1, a stator 2, bearings 31 and 32, a bracket 4, and the circuit board 5.

The rotor 1 is rotatable around the central axis CA extending in the axial direction. As described above, the motor 100 includes the rotor 1. As illustrated in FIG. 1, the rotor 1 includes the shaft 11, a magnet 12, and the fixing member 13.

The shaft 11 extends in the axial direction along the central axis CA. The impeller 200 is connected to an another axial end portion of the shaft 11 of the motor 100.

The magnet 12 is arranged on a radially outer surface of the shaft 11 and surrounds the shaft 11. Different magnetic poles (S pole and V pole) are alternately arranged in the circumferential direction on a surface (for example, a radially outer surface) radially facing at least the stator core 21 of the magnet 12.

The fixing member 13 fixes the bottom plate 201 of the impeller 200 to another axial end portion of the shaft 11. For example, the fixing member 13 sandwiches and holds the bottom plate 201 between a nut 131 screwed to another axial end portion of the shaft 11 and another axial end portion of (an inner ring of) the bearing 31 with an annular washer, a flanged tubular T-shaped washer, and an annular spacer interposed between them. Note that the bearing 31 is a ball bearing in the present example embodiment. However, the present disclosure is not limited to this example, and the bearing 31 may be a rolling bearing or a sliding bearing other than a ball bearing.

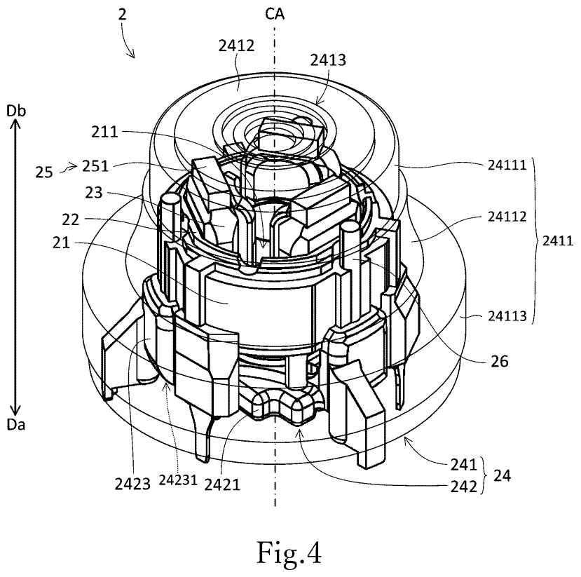

Next, a configuration example of the stator 2 will be described with reference to FIGS. 1 and 4. FIG. 4 is a perspective view illustrating a configuration example of the stator 2. Note that, in FIG. 4, the first inner casing 241 is displayed in a transparent manner in order to facilitate viewing of an internal configuration of the stator 2.

The stator 2 rotationally drives the rotor 1. As described above, the motor 100 includes the stator 2. As illustrated in FIGS. 1 and 4, the stator 2 includes the stator core 21, an insulator 22, a coil portion 23, an inner casing 24, a heat conductor 25, and a male screw 26.

The stator core 21 has an annular shape surrounding the central axis CA. As described above, the stator 2 has the stator core 21. Specifically, the stator core 21 is an annular magnetic body surrounding the shaft 11 and the magnet 12, and is a stacked body of electromagnetic steel plates in the present example embodiment. The stator core 21 faces the magnet 12 in the radial direction. A plurality of slots 211 arranged in the circumferential direction is arranged in a radially inner end portion of the stator core 21. Each of the slots 211 is recessed radially outward from a radially inner surface of the stator core 21 and is open to both axial end surfaces of the stator core 21.

The insulator 22 has electrical insulation and covers a part (axial end surface of the stator core 21, an inner surface of the slot 211, and the like) of the stator core 21.

The coil portion 23 is arranged on the stator core 21. As described above, the stator 2 includes the coil portion 23. A plurality of the coil portions 23 are arranged in the circumferential direction. Note that, in the present example embodiment, the number of the coil portions 23 is three as illustrated in FIG. 3, but is not limited to this example, and may be a plurality other than three. Preferably, the total number of the coil portions 23 is a multiple of three. In this manner, the motor 100 can be driven using three-phase alternating current. However, this example does not exclude a configuration in which the total number of the coil portions 23 is not a multiple of three.

On each of the coil portions 23, a conductive wire (reference numeral is omitted) is arranged in a coil shape on the stator core 21 with the insulator 22 interposed between them. Note that the conductive wire is an enamel-coated copper wire or a metal wire coated with an electrically insulating member, for example, and is wound around a tooth (not illustrated) of the stator core 21 to form the coil portion 23. When drive current is supplied to each of the coil portions 23, the stator 2 is excited to rotate the rotor 1.

The inner casing 24 surrounds the stator core 21, the coil portion 23, and the like and accommodates them in the inside. As described above, the stator 2 includes the inner casing 24. The inner casing 24 holds the stator core 21. The inner casing 24 includes the first inner casing 241 and a second inner casing 242.

The first inner casing 241 has a covered tubular shape that opens toward the one axial direction Da and extends in the axial direction. As described above, the stator 2 includes the first inner casing 241. The first inner casing 241 holds the stator core 21. As illustrated in FIG. 1, the first inner casing 241 includes a tubular portion 2411, a lid portion 2412, and a bearing holder 2413.

The tubular portion 2411 includes the first tubular portion 24111, a second tubular portion 24112, and a third tubular portion 24113. These have a tubular shape extending in the axial direction, and are integrally formed.

The first tubular portion 24111 is arranged further radially inward than the second outer casing 302, in other words, is surrounded by the second outer casing 302. The attachment portion 303 of the outer casing 300 is attached to another axial end portion of the first tubular portion 24111. An outer peripheral surface (that is, a radially outer surface) of the first tubular portion 24111 and a radially outer surface of the attachment portion 303 radially face an inner peripheral surface (that is, a radially inner surface) of the second outer casing 302 with a gap between them, and form the flow passage 503 with the inner peripheral surface of the second outer casing 302.

The second tubular portion 24112 extends from one axial end portion of the first tubular portion 24111 in the one axial direction Da and radially outward. In other words, the second tubular portion 24112 extends more radially outward toward the one axial direction Da. For example, a cross section of the second tubular portion 24112 viewed from the circumferential direction may have a shape protruding in the one axial direction Da and radially inward as illustrated in FIG. 1, or may linearly extend in the one axial direction Da and radially outward. With this shape, the fluid F delivered from the delivery port 502 flows in the one axial direction Da and radially outward along an outer peripheral surface (radially outer surface) of the second tubular portion 24112, and is delivered radially outward of the fluid suction device 500.

Further, the second tubular portion 24112 surrounds and holds the another axial direction Db side of the stator core 21. In other words, the another axial direction Db side of the stator core 21 is fixed to an inner peripheral surface (that is, a radially inner surface) of the second tubular portion 24112.

The third tubular portion 24113 extends in the one axial direction Da from one axial end portion of the second tubular portion 24112. The third tubular portion 24113 surrounds a portion on the one axial direction Da side of the stator core 21, the second inner casing 242, and the like.

The lid portion 2412 expands radially inward from another axial end portion of the first tubular portion 24111 and extends in the circumferential direction. In the present example embodiment, the lid portion 2412 has an annular shape surrounding the shaft 11. As described above, the first inner casing 241 includes the lid portion 2412. The lid portion 2412 expands in the radial direction by surrounding the central axis CA.

In the present example embodiment, a radially inner end portion of the lid portion 2412 holds (an outer ring of) the bearing 31 and functions as the bearing holder 2413. However, the present disclosure is not limited to this example, and the bearing holder 2413 may be a member separate from the lid portion 2412. The bearing holder 2413 rotatably supports the rotor 1 (in particular, the shaft 11) via the bearing 31.

The second inner casing 242 is connected to the first inner casing 241. As described above, the motor 100 includes the second inner casing 242. Specifically, the second inner casing 242 is connected to one axial end portion of the second tubular portion 24112 of the first inner casing 241, and forms a first accommodation space together with the first tubular portion 24111, the second tubular portion 24112, and the lid portion 2412 of the first inner casing 241.

The first accommodation space accommodates a part of the shaft 11, the magnet 12, the stator core 21, the coil portion 23, and the like.

Further, the stator core 21 is sandwiched between the second inner casing 242 and the first inner casing 241 in the axial direction. The second inner casing 242 is in contact with one axial end surface of the stator core 21, for example, is in contact with a radially outer end portion of the one axial end surface. On the other hand, (the second tubular portion 24112 of) the first inner casing 241 is in contact with another axial end surface of the stator core 21, for example, is in contact with a radially outer end portion of the another axial end surface. In this way, heat transferred from the coil portion 23 to the stator core 21 is transferred to the first inner casing 241 and the second inner casing 242. Note that heat transferred to the second inner casing 242 is dissipated to the outside of the second inner casing 242. Alternatively, this heat is transferred to the first inner casing 241 and dissipated to the outside via the shaft 11 and the bearing 31 of the rotor 1, a member (for example, the male screw 26) connecting the first inner casing 241 and the second inner casing 242, or the like. Therefore, heat generated in the coil portion 23 can be efficiently dissipated to the outside.

Next, the second inner casing 242 includes a lid portion 2421, a bearing holder 2422, and a coupling portion 2423. The lid portion 2421 expands radially outward from the central axis CA. When viewed from the axial direction, the bearing holder 2422 is arranged at the central portion of the lid portion 2421.

The bearing holder 2422 is a recessed portion recessed in the one axial direction Da from another axial end surface of the lid portion 2421. However, the present disclosure is not limited to this example, and the bearing holder 2422 may penetrate in the axial direction of the lid portion 2421. The bearing holder 2422 holds (an outer ring of) the bearing 32 and accommodates one axial end portion of the shaft 11. The bearing holder 2422 rotatably supports one axial end portion of the shaft 11 via the bearing 32. Note that the bearing 32 is a ball bearing in the present example embodiment, but is not limited to this example, and may be a rolling bearing or a sliding bearing other than a ball bearing.

The coupling portion 2423 protrudes from a radially outer end portion of the lid portion 2421 to the another axial direction Db. In the present example embodiment, a plurality of the coupling portions 2423 are arranged in the circumferential direction. As illustrated in FIG. 1, the coupling portion 2423 is coupled to the second tubular portion 24112 of the first inner casing 241 by screwing of the male screw 26. For example, a through hole 24231 extending in the axial direction is arranged in the coupling portion 2423. A female screw hole 24114 extending in the another axial direction Db is arranged in the second tubular portion 24112. The male screw 26 is an example of a “screw” of the present disclosure, and is inserted into the through hole 24231 and screwed into the female screw hole 24114. Note that a head portion of the male screw 26 is arranged on the one axial direction Da side of the coupling portion 2423. The coupling portion 2423 is coupled to the second tubular portion 24112 by being sandwiched between the head portion of the male screw 26 and the second tubular portion 24112.

Note that the present disclosure is not limited to the above example, and the through hole 24231 may be arranged on the first inner casing 241 side, and the female screw hole 24114 may be arranged on the second inner casing 242 side. That is, a screw such as the male screw 26 is screwed to the other via one of the first inner casing 241 and the second inner casing 242. The motor 100 further includes the screw. By screwing of the screw, the second inner casing 242 is coupled to the first inner casing 241. In this way, even if the two are not in direct contact with each other, the second inner casing 242 can transfer heat to the first inner casing 241 via a screw such as the male screw 26.

Preferably, as illustrated in FIG. 1, a screw such as the male screw 26 is in contact with a radially outer surface of the stator core 21. In this way, heat can be directly dissipated from the stator core 21 to the screw (male screw 26). This heat is transferred from the screw (male screw 26) to the first inner casing 241 and dissipated to the outside. However, this example does not exclude a configuration in which a screw such as the male screw 26 is not in contact with a radially outer surface of the stator core 21. For example, the male screw 26 may be arranged in a manner radially separated from a radially outer surface of the stator core 21.

Further, the present disclosure is not limited to the above example, and means for coupling the coupling portion 2423 and the second tubular portion 24112 may be other than screwing of a screw such as the male screw 26, and for example, means such as an adhesive, welding, and brazing may be employed.

The heat conductor 25 is arranged between an axial end portion of the coil portion 23 and the inner casing 24 in the axial direction. As described above, the stator 2 includes the heat conductor 25. The heat conductor 25 is in contact with an axial end portion (that is, a coil head) of the coil portion 23 and the inner casing 24.

In this way, an axial end portion of the coil portion 23 can be connected to the inner casing 24 via the heat conductor 25 in a heat conductive manner. Therefore, heat generated inside the motor 100 (in particular, the coil portion 23) is transferred to the inner casing 24 via the heat conductor 25 and dissipated from the inner casing 24 to the outside of the motor 100. Therefore, heat dissipation of the motor 100 (particularly, the coil portion 23) can be improved.

The heat conductor 25 is made from a material having high thermal conductivity, and preferably has electrical insulation.

However, this example does not exclude a configuration in which the heat conductor 25 has low electrical insulation. As the heat conductor 25, a heat dissipation sheet, a heat dissipation adhesive, heat dissipation grease, or the like can be employed. The heat dissipation sheet is, for example, sheet-like composite resin containing a highly thermally conductive filler such as metal powder. Alternatively, the heat dissipation sheet may be a graphite sheet. The heat dissipation adhesive is an adhesive containing a filler having high thermal conductivity such as metal powder. The heat dissipation grease is grease (viscoelastic body) containing a highly thermally conductive filler such as metal powder.

In FIGS. 1 and 4, the heat conductor 25 includes a first heat conductor 251. The first heat conductor 251 is in contact with another axial end portion (that is, a coil head on the another axial direction Db side) of the coil portion 23 and (the lid portion 2412 of) the first inner casing 241. The first heat conductor 251 is arranged between another axial end portion of the coil portion 23 and the lid portion 2412 of the first inner casing 241 in the axial direction.

In this way, another axial end portion of the coil portion 23 can be connected to the first inner casing 241 via the first heat conductor 251 in a heat conductive manner. Therefore, heat generated inside the motor 100 (in particular, the coil portion 23) is transferred to the first inner casing 241 via the first heat conductor 251, and is dissipated from the first inner casing 241 to the outside of the motor 100. Therefore, heat dissipation of the motor 100 (particularly, the coil portion 23) can be improved.

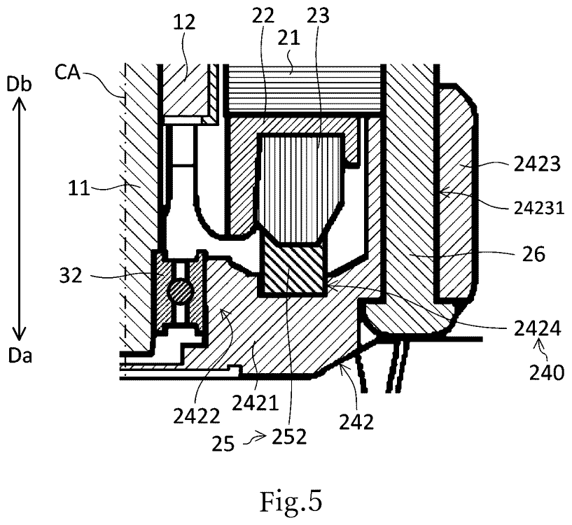

Note that a configuration of the heat conductor 25 is not limited to the example of FIGS. 1 and 4. The heat conductor 25 may have a second heat conductor 252. FIG. 5 is a cross-sectional view illustrating an arrangement example of the second heat conductor 252. Note that FIG. 5 corresponds to a cross-sectional structure of a portion V surrounded by a broken line in FIG. 1.

For example, as illustrated in FIG. 5, the second heat conductor 252 is arranged between another axial end portion of the coil portion 23 and the lid portion 2421 of the second inner casing 242 in the axial direction. The second heat conductor 252 is in contact with one axial end portion (that is, a coil head on the one axial direction Da side) of the coil portion 23 and (the lid portion 2421 of) the second inner casing 242.

In this way, one axial end portion of the coil portion 23 can be connected to the second inner casing 242 via the second heat conductor 252 in a heat conductive manner. Therefore, heat generated inside the motor 100 (in particular, the coil portion 23) is transferred to the second inner casing 242 via the second heat conductor 252 and is dissipated from the second inner casing 242. Alternatively, the heat is transferred to the first inner casing 241 via the second heat conductor 252 and the second inner casing 242, and is dissipated from the first inner casing 241 to the outside of the motor 100. Therefore, heat dissipation of the motor 100 (particularly, the coil portion 23) can be improved.

Here, the heat conductor 25 only needs to include at least one of the first heat conductor 251 and the second heat conductor 252.

Preferably, the inner casing 24 has a recessed portion 240 recessed in the axial direction. A part of the heat conductor 25 is accommodated in the recessed portion 240, and is preferably fitted into the recessed portion 240. In this way, a position in the radial direction and the circumferential direction of the heat conductor 25 can be easily determined. Note that the recessed portion 240 includes at least one of a first recessed portion 2414 and a second recessed portion 2424.

For example, in FIG. 1, the first recessed portion 2414 is arranged in the first inner casing 241. The first recessed portion 2414 is arranged on one axial end surface of the lid portion 2412 of the first inner casing 241 and is recessed in the another axial direction Db. The first inner casing 241 has the first recessed portion 2414. A part of the heat conductor 25 is accommodated in the first recessed portion 2414. More preferably, a part of the first heat conductor 251 is fitted into the first recessed portion 2414. In this way, a position in the radial direction and the circumferential direction of the first heat conductor 251 can be easily determined. However, this example does not exclude a configuration in which a part of the first heat conductor 251 is not accommodated or fitted into the first recessed portion 2414, and does not exclude a configuration in which the first recessed portion 2414 is not arranged in the first inner casing 241.

Further, in FIG. 5, the second recessed portion 2424 is arranged in the second inner casing 242. The second recessed portion 2424 is arranged on one axial end surface of the lid portion 2421 of the second inner casing 242 and is recessed in the one axial direction Da. The second inner casing 242 has the second recessed portion 2424. A part of the second heat conductor 252 is accommodated in the second recessed portion 2424. More preferably, a part of the second heat conductor 252 is fitted into the second recessed portion 2424. In this way, a position in the radial direction and the circumferential direction of the second heat conductor 252 can be easily determined. However, this example does not exclude a configuration in which a part of the second heat conductor 252 is not accommodated or fitted into the second recessed portion 2424, and does not exclude a configuration in which the second recessed portion 2424 is not arranged in the second inner casing 242.

Further, preferably, the individual heat conductor 25 is arranged between an axial end portion of each of the coil portions 23 and the inner casing 24. For example, in FIG. 1, the individual first heat conductor 251 is arranged between another axial end portion of each of the coil portions 23 and (the lid portion 2412 of) the first inner casing 241. Further, in FIG. 5, the individual second heat conductor 252 is arranged between one axial end portion of each of the coil portions 23 and (the lid portion 2421 of) the second inner casing 242.

In this way, heat generated in each of the coil portions 23 can be transferred to the inner casing 24 via the individual heat conductor 25. Total volume of the heat conductor 25 can be further reduced as compared with a configuration in which the single heat conductor 25 is arranged at an axial end portion of a plurality of the coil portions 23. That is, since the material of the heat conductor 25 can be further reduced, manufacturing cost can be reduced. Therefore, productivity of the motor 100 is improved.

Further, a plurality of the heat conductors 25 arranged in a coil head of each of the coil portions 23 are arranged in the circumferential direction when viewed from the axial direction. For example, on the another axial direction Db side of the coil portion 23, a plurality of the first heat conductors 251 are arranged in the circumferential direction when viewed from the axial direction. On the one axial direction Da side of the coil portion 23, a plurality of the second heat conductors 252 are arranged in the circumferential direction as viewed from the axial direction. Each of the numbers of the first heat conductors 251 and the second heat conductors 252 is three in the present example embodiment, and is preferably the same as the number of the coil portions 23. More preferably, the number of the heat conductors 25 individually arranged with respect to a coil head of each of the coil portions 23 is a multiple of three. That is, as described above, the total number of the coil portions 23 is also a multiple of three. In this manner, heat dissipation of each of the coil portions 23 of the motor 100 driven by three-phase alternating current can be improved.

At this time, preferably, the heat conductors 25 are arranged at equal intervals in the circumferential direction.

For example, on the another axial direction Db side of the coil portion 23, the first heat conductors 251 are arranged at equal intervals in the circumferential direction. On the one axial direction Da side of the coil portion 23, the second heat conductors 252 arranged are at equal intervals in the circumferential direction. In this manner, contact portions between the heat conductors 25 and the inner casing 24 are arranged at equal intervals in the circumferential direction. For this reason, it is possible to reduce a deviation in distribution in the circumferential direction of heat transferred from each of the heat conductors 25 to the inner casing 24. Therefore, heat dissipation of the inner casing 24 to the outside of the motor 100 can be improved. However, this example does not exclude a configuration in which at least a part of the heat conductors 25 is arranged at a different interval in the circumferential direction.

Further, the above example does not exclude a configuration in which the number of at least one of the first heat conductors 251 and the second heat conductors 252 is less than the number of the coil portions 23.

For example, the single first heat conductor 251 may be in contact with another axial end portion of at least a part of the coil portions 23. Further, the single annular or arcuate first heat conductor 251 may be in contact with another axial end portion of a plurality of or all the coil portions 23. Further, the first heat conductor 251 only needs to be in contact with another axial end portion of at least one of the coil portions 23. In other words, the first heat conductor 251 does not need to be in contact with another axial end portion of any one of the coil portions 23.

Further, the single second heat conductor 252 may be in contact with one axial end portion of at least a part of the coil portions 23. Further, the single annular or arcuate second heat conductor 252 may be in contact with one axial end portion of a plurality of or all the coil portions 23. Further, the second heat conductor 252 may be in contact with one axial end portion of at least one of the coil portions 23. In other words, the second heat conductor 252 does not need to be in contact with one axial end portion of any one of the coil portions 23.

Next, a configuration example of the bracket 4 will be described with reference to FIG. 1. The bracket 4 has a covered tubular shape that is open toward the another axial direction Db and extends in the axial direction. The bracket 4 is arranged at one axial end portion of the third tubular portion 24113 of the first inner casing 241, and forms a second accommodation space together with the second tubular portion 24112 and the third tubular portion 24113 of the first inner casing 241 and the second inner casing 242. The second accommodation space accommodates the circuit board 5.

The bracket 4 includes a tubular portion 41 and a lid portion 42. The tubular portion 41 extends from one axial end portion of the third tubular portion 24113 of the first inner casing 241 to the one axial direction Da side and surrounds the circuit board 5. The lid portion 42 expands radially inward from one axial end portion of the tubular portion 41. Further, when viewed from the axial direction, an opening 421 is arranged in an outer edge portion of the lid portion 42. Through the opening 421, the above second accommodation space is connected to the outside of the fluid suction device 500.

Next, the circuit board 5 will be described with reference to FIG. 1. The circuit board 5 has a plate shape expanding in a direction (for example, the radial direction) intersecting the central axis CA, and is arranged between the lid portion 2421 of the second inner casing 242 and the lid portion 42 of the bracket 4 in the axial direction. In the present example embodiment, the circuit board 5 is attached to the lid portion 2421 using an attachment member (reference numeral is omitted) extending in the one axial direction Da from the lid portion 2421.

A drive circuit (not illustrated) of the stator 2 and the like are mounted on the circuit board 5. Further, a lead wire of the coil portion 23 and an external connection wire (both not illustrated) are connected to the circuit board 5. Note that the lead wire is an end portion of a conductive wire constituting the coil portion 23. The external connection wire is a connection wire drawn from the circuit board 5 to the outside of the fluid suction device 500, and is connected to an external device or the like.

The example embodiment of the present disclosure is described above. Note that the scope of the present disclosure is not limited to the above example embodiment. The present disclosure is implemented by adding various modifications to the above example embodiment within a range not departing from the spirit of the disclosure. Further, matters described in the above example embodiment can be optionally combined together as appropriate within a range where no inconsistency occurs.

For example, in the above example embodiment, the present disclosure is applied to the motor 100 mounted on the fluid suction device 500. However, the present disclosure is not limited to this example, and may be applied to a motor mounted on a device other than the fluid suction device 500, or may be applied to a motor used alone.

The example embodiments described so far will be collectively described hereinafter.

For example, a motor disclosed herein has a configuration (first configuration) including a rotor rotatable around a central axis extending in an axial direction; and a stator to rotationally drive the rotor; wherein the stator includes an annular stator core surrounding the central axis; a coil portion located in the stator core; an inner casing to surround and accommodate the stator core and the coil portion therein to hold the stator core; and a heat conductor in contact with an axial end portion of the coil portion and the inner casing.

Note that the motor of the first configuration may have a configuration (second configuration), in which the inner casing includes a first inner casing that has a covered tubular shape opening toward one axial direction and is structured to hold the stator core; and a second inner casing coupled to the first inner casing; and the heat conductor includes at least one of: a first heat conductor in contact with another axial end portion of the coil portion and the first inner casing; and a second heat conductor in contact with one axial end portion of the coil portion and the second inner casing.

Further, the motor of the first or second configuration may have a configuration (third configuration), in which the inner casing includes a recessed portion that is recessed in the axial direction; and a portion of the heat conductor is accommodated in the recessed portion.

Further, the motor according to any of the first to third configurations may have a configuration (fourth configuration), in which the inner casing includes a first inner casing that has a covered tubular shape opening toward one axial direction to hold the stator core; and a second inner casing coupled to the first inner casing; the second inner casing is in contact with one axial end surface of the stator core; and another axial end surface of the stator core is in contact with the first inner casing.

Further, the motor of a fourth configuration may have a configuration (fifth configuration) of further including a screw screwed to one of the first inner casing and the second inner casing via another one; wherein the second inner casing is coupled to the first inner casing via the screw.

Further, the motor of the fifth configuration may have a configuration (sixth configuration), in which the screw is in contact with a radially outer surface of the stator core.

Further, the motor of any of the first to sixth configurations may have a configuration (seventh configuration), in which a plurality of the coil portions are located in a circumferential direction; and the individual heat conductor is located between an axial end portion of each of the coil portions and the inner casing.

Further, the motor of the seventh configuration may have a configuration (eighth configuration), in which the individual heat conductors are arranged at equal or substantially equal intervals in the circumferential direction.

Further, the motor according to any of the first to eighth configurations may have a configuration (ninth configuration), in which a total number of the coil portions is a multiple of three; and the individual heat conductor is located between an axial end portion of each of the coil portions and the inner casing.

Further, a fluid suction device disclosed in the present description is a fluid suction device capable of suctioning fluid, the fluid suction device having a configuration (tenth configuration) of including: the motor according to an example embodiment of the present disclosure; an impeller rotatable around the central axis together with the rotor of the motor; and an outer casing surrounding a portion on another axial direction side of the motor and the impeller; wherein a flow passage of the fluid is located between the outer casing and the portion on another axial direction side of the motor.

Further, a cleaner disclosed in the present description has a configuration (eleventh configuration) of including the fluid suction device of the tenth configuration.

The present disclosure is useful for heat dissipation of a motor (particularly a coil portion) mounted on various devices.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor rotatable around a central axis extending in an axial direction; and
a stator to rotationally drive the rotor; wherein
the stator includes:
an annular stator core surrounding the central axis;
a coil portion located in the stator core;
an inner casing to surround and accommodate the stator core and the coil portion therein and to hold the stator core; and
a heat conductor in contact with an axial end portion of the coil portion and the inner casing.

2. The motor according to claim 1, wherein
the inner casing includes:
a first inner casing that has a covered tubular shape opening toward one axial direction to hold the stator core; and
a second inner casing coupled to the first inner casing; and
the heat conductor includes at least one of:
a first heat conductor in contact with another axial end portion of the coil portion and the first inner casing; and
a second heat conductor in contact with one axial end portion of the coil portion and the second inner casing.

3. The motor according to claim 1, wherein
the inner casing includes a recessed portion that is recessed in the axial direction; and
a portion of the heat conductor is accommodated in the recessed portion.

4. The motor according to claim 1, wherein
the inner casing includes:
a first inner casing that has a covered tubular shape opening toward one axial direction to hold the stator core; and
a second inner casing coupled to the first inner casing;
the second inner casing is in contact with one axial end surface of the stator core; and
another axial end surface of the stator core is in contact with the first inner casing.

5. The motor according to claim 4, further comprising a screw screwed to one of the first inner casing and the second inner casing via another one; wherein
the second inner casing is coupled to the first inner casing via the screw.

6. The motor according to claim 5, wherein the screw is in contact with a radially outer surface of the stator core.

7. The motor according to claim 1, wherein
a plurality of the coil portions are located in a circumferential direction; and
the individual heat conductor is located between an axial end portion of each of the coil portions and the inner casing.

8. The motor according to claim 7, wherein the individual heat conductors are arranged at equal or substantially equal intervals in the circumferential direction.

9. The motor according to claim 1, wherein
a total number of the coil portions is a multiple of three; and
the individual heat conductor is located between an axial end portion of each of the coil portions and the inner casing.

10. A fluid suction device capable of suctioning fluid, the fluid suction device comprising:
the motor according to claim 1;
an impeller rotatable around the central axis together with the rotor of the motor; and
an outer casing surrounding a portion on another axial direction side of the motor and the impeller; wherein
a flow passage of the fluid is located between the outer casing and the portion on another axial direction side of the motor.

11. A cleaner comprising the fluid suction device according to claim 10.
